(19) United States
(12) Patent Application Publication
(10) Pub. No.: US 2017/0336239 A1
(43) Pub. Date: Nov. 23, 2017

(54) SYSTEM AND METHOD FOR ESTIMATING VEHICLE FUEL LEVEL

(71) Applicant: Caterpillar of Australia Pty Ltd, Tullamarine (AU)

(72) Inventor: Darryl V. Collins, Jindalee (AU)

(73) Assignee: Caterpillar of Australia Pty Ltd, Tullamarine (AU)

(21) Appl. No.: 15/534,935

(22) PCT Filed: Dec. 9, 2015
(86) PCT No.: PCT/AU2015/050775

§ 371 Date: Jun. 9, 2017

(30) Foreign Application Priority Data
Dec. 12, 2014 (AU) 2014905046

(51) Int. Cl. G01F 23/00; G07C 5/08; B60K 15/03; G07C 5/00

(52) U.S. Cl. CPC G01F 23/0076; G07C 5/085; B60K 15/03; B60K 2015/03197; G07C 5/008; B60K 2015/03217

(57) ABSTRACT

Described herein is a computer-implemented method for estimating a true fuel level of a vehicle. The method comprises: accessing an estimate as to a current state of the vehicle, the current state of the vehicle comprising a current fuel level state; predicting the state of the vehicle at a future time based on the current state of the vehicle; accessing a measured state of the vehicle based on sensor data; estimating a true state of the vehicle based on the predicted state of the vehicle and the measured state of the vehicle, the true state of the vehicle comprising an estimate as to the true fuel level of the vehicle; and outputting the estimated true fuel level of the vehicle.

### TECHNICAL FIELD

The present disclosure relates to systems and methods for estimating the fuel level of a vehicle. The disclosure is particularity suitable for estimating the fuel levels of heavy vehicles, such as those that operate at mining worksites, and will be described in relation to that exemplary but non-limiting application.

### BACKGROUND

Most vehicles in use today run on a liquid fuel such as gasoline (petrol) or diesel. As vehicles are operated fuel is, of course, consumed which eventually leads to the vehicle needing to be refuelled.

Determining the most appropriate time for a given vehicle to refuel is important and can significantly impact on the productivity of the vehicle. On one hand it is highly desirable to prevent a vehicle from running dry. This typically encourages a conservative approach to vehicle refuelling (i.e. an approach that has the vehicle refuelling more often than may be strictly necessary). On the other hand, refuelling more often than is necessary wastes time that the vehicle could be productively operating.

The balance between refuelling too frequently and too infrequently is well illustrated in a typical mining worksite and, for example, the operation of a haulage vehicle. Haulage vehicles are heavy vehicles operated to haul ore/material from one location in a mining worksite (e.g. a loading location where material is extracted from the mine) to another location (e.g. a dumping location where the material is stockpiled for further processing). This movement of material is generally critical to the productivity of the mine, and time haulage vehicles spend not hauling material (e.g. due to refuelling) impacts on the productivity of the entire worksite.

Because of this, unnecessary refuelling of haulage vehicles (and their removal from productive operation) is undesirable. Even less desirable, though, is for a haulage machine to be caught in a position where it has insufficient fuel to attend a refuelling station or, even worse, for a haulage vehicle to run dry.

If a haulage machine has insufficient fuel to attend a refuelling station a refuelling vehicle has to be assigned to attend the haulage vehicle in the middle of the worksite. This can be time consuming and can disrupt the operation of other vehicles/machines attempting to operate on the worksite.

A haulage machine running dry can be even more problematic. At the very least a refuelling vehicle needs to be assigned (or the haulage vehicle towed) as described above. Furthermore, such a vehicle running dry can cause mechanical damage to the engine requiring still further time (and skilled labour) to fix.

Although haulage vehicles do have fuel level sensors, a variety of factors can lead to such sensors being unreliable or the data received from such sensors being noisy. Even were the fuel level reported by a sensor is reliable, however, an accurate report of the current fuel level will not provide intelligence on the optimal time for the vehicle to refuel.

Reference to any prior art in this specification is not, and should not be taken as, an acknowledgment or suggestion that this prior art forms part of the common general knowledge in Australia or any other jurisdiction.

### SUMMARY

Described herein is a computer-implemented method for estimating a true fuel level of a vehicle, the method comprising: accessing an estimate as to a current state of the vehicle, the current state of the vehicle comprising a current fuel level state; predicting the state of the vehicle at a future time based on the current state of the vehicle; accessing a measured state of the vehicle based on sensor data; estimating a true state of the vehicle based on the predicted state of the vehicle and the measured state of the vehicle, the true state of the vehicle comprising an estimate as to the true fuel level of the vehicle; and outputting the estimated true fuel level of the vehicle.

Also described herein is a non-transitory computer-readable medium comprising instructions which, when implemented by a computer processing system, cause the computer processing system to: access an estimate as to a current state of a vehicle, the current state of the vehicle comprising a current fuel level state; predict the state of the vehicle at a future time based on the current state of the vehicle; access a measured state of the vehicle based on sensor data; estimate a true state of the vehicle based on the predicted state of the vehicle and the measured state of the vehicle, the true state of the vehicle comprising an estimate as to the true fuel level of the vehicle; and output the estimated true fuel level of the vehicle.

Also described herein is a computer processing system comprising one or more processors configured to: access an estimate as to a current state of a vehicle, the current state of the vehicle comprising a current fuel level state; predict the state of the vehicle at a future time based on the current state of the vehicle; access a measured state of the vehicle based on sensor data; estimate a true state of the vehicle based on the predicted state of the vehicle and the measured state of the vehicle, the true state of the vehicle comprising an estimate as to the true fuel level of the vehicle; and output the estimated true fuel level of the vehicle

The measured state of the vehicle may comprise a measured fuel level sensed by a fuel level sensor of the vehicle.

The state of the vehicle at the future time may be predicted using a difference equation.

An error associated with the estimated true state of the vehicle may be estimated.

The state of the vehicle may be defined by a state vector.

The state vector may comprise elements defining: a fuel level of the vehicle, a fuel burn rate of the vehicle when the vehicle is stationary; a fuel burn rate of the vehicle per effective flat haul meter when empty; and a fuel burn rate of the vehicle per effective flat haul meter when loaded.

Alternatively, the state vector may comprise elements defining: a fuel level of the vehicle, a fuel burn rate of the vehicle during loading, a fuel burn rate of the vehicle when the vehicle is traveling empty, a fuel burn rate of the vehicle when the vehicle is traveling loaded, a fuel burn rate of the vehicle when the vehicle is stationary empty, and a fuel burn rate of the vehicle when the vehicle is stationary loaded.

A refuelling assignment may be determined based on the estimated true fuel level of the vehicle.

As used herein, the term “comprises” (and grammatical variants thereof) is used inclusively and does not exclude the existence of additional features, elements or steps.

### BRIEF DESCRIPTION OF THE DRAWINGS

Various aspects and features of the disclosure will be described with reference to the following figures which are provided for the purposes of illustration and by way of non-limiting example only.

FIG. 1 is a depiction of a vehicle;

FIG. 2 is a block diagram of a computer processing system;

FIG. 3 is a flow diagram illustrating data processing stages in accordance with an embodiment.

### DETAILED DESCRIPTION

The present disclosure relates to computer processing systems and computer implemented methods for estimating the fuel level of a vehicle. The systems and methods will be described in relation to estimating the fuel level of a mining worksite haulage vehicle, but it will be appreciated that the principles described herein can be applied to a variety of vehicles operating in a variety of contexts.

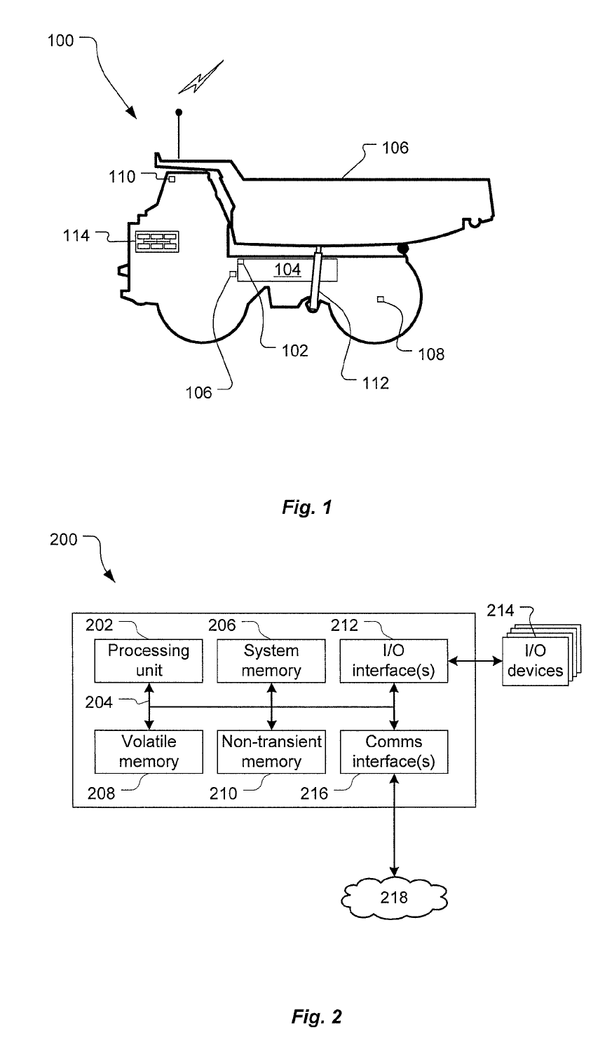

FIG. 1 provides a depiction of a vehicle 100, in this case a haulage vehicle. Vehicle 100 is equipped with a number of sensors (or sensor systems) which sense data relevant to the operation of the vehicle 100. In this particular example vehicle 100 is equipped with:
A fuel level sensor 102 for sensing the volume of fuel in a fuel tank 104. Fuel level sensor 102 may, for example, be a SONAR sensor.
A fuel usage sensor 106 for sensing the usage of fuel by the vehicle 100. The fuel usage sensor 106 will typically be instrumentation on a fuel pump which provides a reading on fuel usage.
A position sensor 108 (e.g. a GPS sensor) for sensing the position of the vehicle 100.
A payload sensor 110 for sensing the weight of the payload carried in the tray 112 of the vehicle 100.

In the present embodiment vehicle 100 is also equipped with a computer processing system 114 which is in communication with the various vehicle sensors in order to receive sensed information from them and/or control their operation.

FIG. 2 is a block diagram of one type of computer processing system 200 suitable for use as a vehicle computer processing system 114. Computer processing system 200 comprises a processing unit 202 which may be a single computational processing device (e.g. a microprocessor or other computational device) or a plurality of computational processing devices. Through a communications bus 204 the processing unit 202 is in data communication with a system memory 206 (e.g. a read only memory storing a BIOS for basic system operations), volatile memory 208 (e.g. random access memory such as one or more DRAM modules), and non-transient memory 210 (e.g. one or more hard disk drives, solid state drives, flash memory devices and suchlike). Instructions and data to control operation of the processing unit 202 are stored on the system, volatile, and/or non-transient memory 206, 208, and 210.

The computer processing system 200 also comprises one or more input/output interfaces 212 by which the system 200 interfaces with input/output devices 214. As will be appreciated, a wide variety of input/output devices may be used, for example keyboards, pointing devices, touch-screens, touch-screen displays, displays, microphones, speakers, hard drives, solid state drives, flash memory devices and the like.

In the context of the vehicle computer processing system 114, the various vehicle sensors may be provided/configured as input/output devices 214 which communicate with the system 114 via appropriate input/output interfaces 212.

Computer processing system 200 further comprises one or more communications interfaces 216, such as a Network Interface Card or telecommunications modem (e.g. a 3G or 4G modem or the like). A communications interface 216 allows for wired or wireless connection to a communications network 218. Communication with the communications network 218 (and other devices connected thereto) is typically by the protocols set out in the layers of the OSI model of computer networking. For example, applications/software programs being executed by the computer processing system 200 may communicate using one or more transport protocols, e.g. the Transmission Control Protocol (TCP, defined in RFC 793) or the User Datagram Protocol (UDP, defined in RFC 768). Alternative communications protocols may, of course, be used.

The computer processing system 200 stores in memory and runs one or more applications allowing operators to operate the system 200. Such applications will typically comprise at least an operating system such as Microsoft Windows®, Apple OSX, Unix, or Linux. As described in further detail below, the computer processing system 200 also stores in (or accesses from) memory instructions for processing sensor data to estimate the fuel level of the vehicle 100.

It will be appreciated that computer processing system 200 is an example of a general purpose computer processing system. The specific components and architecture of a particular computer processing system (e.g. vehicle processing system 114), and the software executing thereon, may of course vary. Suitable computer processing systems may have additional, alternative, or fewer components than those depicted. It will also be appreciated that FIG. 2 does not illustrate all functional or physical components of a computer processing system. For example, no power supply or power supply interface has been depicted, however system 200 will either carry a power supply or be configured for connection to a power supply (or both).

### INDUSTRIAL APPLICABILITY

As described above, embodiments generally relate to a computer processing system 200 configured to estimate the fuel level of a vehicle such as vehicle 100.

In one embodiment the vehicle computer processing system 114 is configured to access and process the relevant information (e.g. sensed data and, if used, terrain data) and estimate the fuel level of the vehicle 100.

In alternative embodiments a remote computer processing system remote from the vehicle 100 (e.g. in a control centre or similar) is configured to receive/access the relevant sensor data from the sensors of the vehicle 100 (and access terrain data) and process the data to estimate the vehicle fuel level. In this case the remote computer processing system may have a similar architecture and similar components as computer processing system 200 described above (though, when compared to a vehicle computer processing system 114, a remote computer processing system will typically have greater processing power).

Generally speaking, the present embodiment processes the available data using a Kalman filter to estimate a current fuel level of a vehicle. The available data received/accessed by the computer processing system 200 in one embodiment comprises:
Current fuel level, e.g. in gallons (as reported by the fuel level sensor 102)
Fuel usage, e.g. gallons per hour (as sensed by the fuel usage sensor 106).
Current position of the vehicle, e.g. latitude, longitude, altitude (as sensed by the position sensor 108).
Current weight of the payload, e.g. in tons (as sensed by the payload sensor 110).

In addition, computer system 200 has access to worksite terrain data. Worksite terrain data is obtained from surveys of the worksite in which the vehicle 100 operates and generally speaking comprises positional information (e.g. longitude, latitude, elevation) of worksite locations such as roads, loading locations, dumping locations, refuelling locations etc. The worksite terrain data may be in any appropriate format, for example a DXF file or similar containing polygon data representative of the worksite terrain, but in general terrain data describes terrain in terms of x, y, and z coordinates (e.g. latitude, longitude and altitude—either in an absolute sense or according to a local referencing scheme). Worksite terrain data is stored on non-transient memory (such as memory 210) or accessed from memory of another computer system.

During operation, vehicle 100 transitions through a number of states. For example, a haulage vehicle 100 operating in a mine site will typically have a work cycle involving travelling to a loading location, queuing at the loading location, loading, travelling to a dumping location, queuing at the dumping location, dumping (and repeat).

Computer system 200 also has access to or calculates state information as to the state of the vehicle 100 at a particular time or times. For a haulage vehicle 100 involved in hauling material from a loading location to a dumping location the applicable states may comprise:
Loading, when vehicle 100 starts to be loaded by a loading machine.
Travelling loaded, when vehicle 100 is travelling loaded (e.g. between a loading location and a dumping location).
Stationary loaded, when vehicle 100 is stationary and loaded with the engine running (e.g. at a dumping location waiting to dump the load).
Dumping, when vehicle 100 is dumping the load.
Travelling empty, when vehicle 100 is travelling empty (e.g. between a dumping location and a loading location).
Stationary empty, when vehicle 100 is stationary and empty with the engine running (e.g. at a loading location waiting to be loaded by a loading machine).

The state of a vehicle may be determined in a variety of ways. For example, state messages may be generated and communicated based on manual input of machine operators—e.g. an operator manually sending a message on commencement/transition to a particular state.

Alternatively, the state of the vehicle 100 (and/or state transitions) can be derived from sensor data received from/about the vehicle 100. For example, if the payload sensor 110 indicates the vehicle 100 is loaded and the location sensor 108 (or an alternative sensor such as a speedometer) indicates the vehicle 100 is moving, the state of the vehicle 100 can be inferred to be “travelling loaded”. Conversely, if the location sensor 108 (or other sensor) indicates the vehicle is moving while the payload sensor 110 indicates the vehicle 100 is empty, the state can be inferred as “travelling empty”. Similar inferences can be made for other states. E.g. stationary empty (position/velocity sensor reporting no velocity and payload sensor reporting tray is empty); stationary loaded (position/velocity sensor reporting no velocity and payload sensor reporting tray is full); dumping (payload sensor reporting decreasing weight in tray over relatively short time period); loading (payload sensor reporting increasing weight in tray over relatively short time period).

The time spent by the vehicle 100 in a given state can be calculated based on state transitions. I.e. if the machine transitions from loading to traveling loaded at time x, the transitions from travelling loaded to stationary loaded at time y, the time spent travelling loaded can be calculated by subtracting x from y.

In addition, the routes taken by the vehicle 100 over the course of the work cycle are generally known or can be calculated based on worksite terrain data. For example, the normal haulage cycle may comprise two known routes: the route from the dumping location to the loading location, and the route from the loading location to the haulage location. Information that is known or calculated by these routes may comprise, for example, the actual route taken, the length of the route, the elevation profile of route (defining elevation gain/loss along the route), rolling resistance for particular vehicles that may traverse the route.

Using the available data a Kalman filter is used to estimate a current fuel level of the vehicle 100. The general fuel estimation process will be described followed by two specific examples of Kalman filter inputs/terms that can be used in the process to estimate a current fuel level.

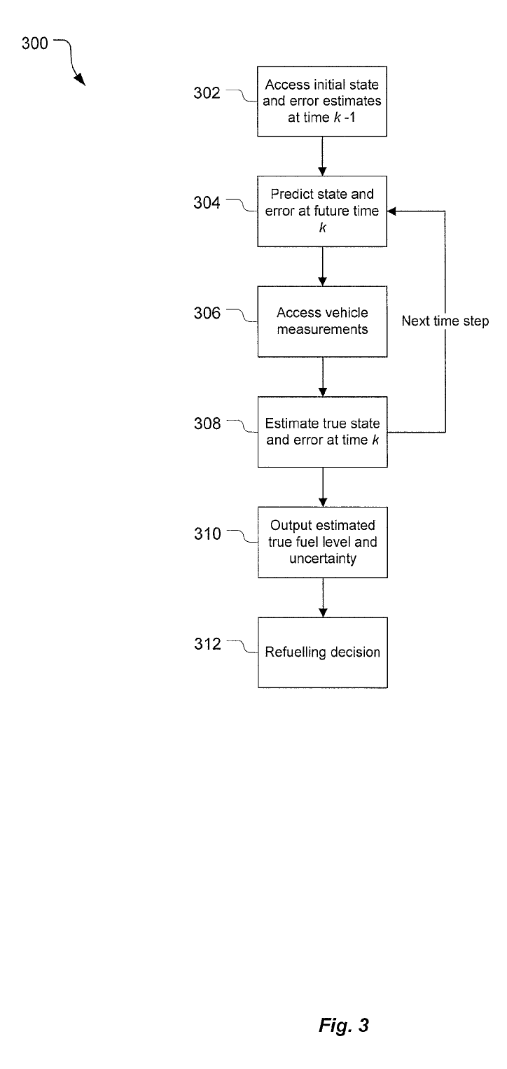

FIG. 3 depicts a computer implemented method 300 for determining a refuelling operation in accordance with an embodiment. Whether method 300 is performed by a vehicle processing system 114 or a remote computer processing system (or, indeed, by a computer processing system with distributed processing units), the computer processing system 200 is configured to implement the method by software comprising instructions and data. The instructions are executed by the processing unit 202 to implement the relevant processing stages. The software is stored on a non-transient computer-readable medium, such as non-transient memory 210 or an external data storage device which can interface with the computer processing system 200 (via, for example, an I/O interface 212 or a communications interface 216). The software may be provided to computer processing system 200 by means of a data signal in a wired or wireless transmission channel over a communications interface 216.

At 302, system 200 accesses initial estimates of the state of the vehicle 100 (defined by state vector x) and the error associated with the estimated state (defined by an error covariance matrix P). These estimates may be received from user input (via an appropriate user interface) or generated by system 200.

At 304, system 200 generates a prediction as to the state vector x and error covariance matrix P at a future time (k).

These predictions are based on estimates of the current state of the system (defined by state vector x at time k−1) and the error associated therewith (defined by the error covariance matrix P at time k−1). Initially these estimates are the estimates accessed at 302. As process 300 continues, however, these estimates are the state and error estimates made at 310.

System 200 predicts the state of the state vector x at time k using predicted state estimate equation:

\hat{x}_{k|k-1}=Fₖ\hat{x}_{k-1|k-1}+wₖ (Predicted State Estimate Equation)

For equations used herein the notation of \ddot{x}_{a|b} indicates an estimate of x at time a, the estimate taking into account observations made up to and including time b.

F is the state transition matrix. w is an estimate of the noise associated with the modelling, and is presumed to be normally distributed with the estimated process noise covariance Q at time k.

In this particular embodiment control input is not considered so no control vector is defined. In alternative embodiments control input may be taken into account by definition of a control input u and control matrix B which relates the control input u to the state vector x (i.e. by addition of the term Bₖuₖ to the right hand side of the difference equation). Control input could include, for example, engine revs, throttle position or the like.

System 200 predicts the error covariance matrix P at time k using a predicted estimate covariance equation:

P_{k|k-1}=FₖP_{k-1|k-1}Fₖ^{T}+Qₖ (Predicted Estimate Covariance Equation)

Where Q is the estimated process noise covariance.

At 306, system 200 accesses sensor data providing information on the measured/sensed state of the vehicle 100 at time k (i.e. the same time as estimated at 304). This data is mapped/input to a measurement “vector” z (though in the present embodiment the measurement is a scalar representing the fuel level of the vehicle).

Measurement vector z is related to the state vector x according to the measurement equation:

zₖ=Hₖxₖ+vₖ (Measurement Equation)

Where H is the transformation matrix. vₖ is an estimate of the noise associated with the measurement presumed to be normally distributed with the observation noise covariance R at time k.

Where processing is performed by the vehicle processing system 114, sensor data may be received directly from the sensors (e.g. via i/o interfaces 212). Where processing is performed by a remote computer processing system a variety of options are possible. For example, the vehicle sensors may communicate sensed data to the vehicle computer processing system 114 which, in turn, communicates the sensor data to the remote computer processing system in real time (e.g. using communications interfaces 216 and communications network 218). Alternatively, one or more of the vehicle sensors may be configured to communicate sensed data directly to the remote computer processing system (rather than via the vehicle processing system 114) via a dedicated sensor communications interface.

At 308 the estimates as to the state and error at time k (generated at 304) are compared to the measurements made at 306 in order to generate estimates as to the “true” state of the state vector x at the current time k and the “true” state of the error covariance matrix P at the current time k.

System 200 estimates the true state of the state vector x at time k using an updated state estimate equation and innovation/measurement residual equation:

\hat{x}_{k|k}=\hat{x}_{k|k-1}+Kₖ\tilde{y}ₖ (Updated State Estimate Equation)

\tilde{y}ₖ=zₖ−Hₖ\hat{x}_{k|k-1} (Innovation/Measurement Residual Equation)

Where K is the Kalman gain calculated (in this instance) by a Kalman gain equation and innovation/residual covariance equation:

Kₖ=P_{k|k-1}Hₖ^{T}Sₖ⁻¹ (Kalman Gain Equation)

Sₖ=HₖP_{k|k-1}Hₖ^{T}+Rₖ (Innovation/Residual Covariance Equation)

Where R is the observation noise covariance matrix.

System 200 estimates the true state of the error covariance matrix P at time k using an updated estimate covariance equation:

P_{k|k}=(I−KₖHₖ)P_{k|k-1} (Predicted Estimate Covariance Equation)

At 310 system 200 outputs the estimated true fuel level of the vehicle (from the estimated true state vector x) and the uncertainty associated with that estimate (from the estimated true error covariance matrix P).

At 312 system 200 makes a refuelling decision based on the estimated true fuel level and uncertainty output at 310. At a general level this refuelling decision is a decision as to whether vehicle 100 should continue with its currently assigned tasks (e.g. continue on the next haulage workcycle) or instead be assigned to refuelling based on an estimate as to whether a given vehicle has sufficient fuel (per the outputs at 310) to perform the next task currently assigned for that vehicle or not.

For example, a haulage vehicle may be assigned a haulage workcycle involving travelling to a loading location, loading, travelling to a dumping location, dumping, travelling to the loading location etc. An estimate of the fuel usage incurred in a given cycle (e.g. from dumping to dumping) is calculated based on historical performance. For example, the average fuel usage of vehicles of the same type completing a cycle may be used, or (as a more conservative estimate) the maximum amount of fuel used by the same type of vehicle in completing that cycle may be used.

If the estimated fuel level indicates that the vehicle is unlikely to be able to complete a further cycle with an acceptable fuel level remaining the vehicle is assigned to refuel instead of commencing a further work cycle. In this sense being able to complete a further work cycle with an acceptable fuel level remaining is based on the likelihood of the fuel level of the vehicle being sufficient at the end of the next work cycle to attend a refuelling location and refuel. If it is likely the vehicle will not have sufficient fuel to complete the cycle and attend the refuelling location completing the vehicle will not have an acceptable fuel level remaining at the completion of the further cycle.

As indicated, process 300 is typically continuous. Once generated, the estimates as to the true state and error calculated at 308 are then used as the “k−1” states at 304.

It will be appreciated that process 300 may be varied. For example: a given functional block may be implemented in an alternative way to achieve the relevant result; a given functional block may be split into multiple functional blocks to achieve the relevant result; one or more functional blocks may be combined into a single functional block to achieve the relevant result. Additionally, in some cases the order in which the functional blocks are performed may be varied.

Two specific examples of how process 300 may be implemented are described below, both in accordance with embodiments.

### Example 1

In this embodiment, state vector x is:

x=[X X′_{Loading}X′_{TE}X′_{TL}X′_{SE}X′_{SL}]^{T} (State Vector 1)

Where State Vector 1 defines:
X=the fuel level of the vehicle 100.
X′_{Loading}=the fuel burn rate of the vehicle 100 during loading.
X′_{TE}=the fuel burn rate of the vehicle 100 when the vehicle 100 is traveling empty.
X′_{TL}=the fuel burn rate of the vehicle 100 when the vehicle 100 is travelling loaded.
X′_{SE}=the fuel burn rate of the vehicle 100 when the vehicle 100 is stationary and empty (with the engine running).
X′_{SL}=the fuel burn rate of the vehicle 100 when the vehicle 100 is stationary and loaded (with the engine running).

At 302 an initial estimate as to the state of the system (as defined by state vector x) is made. The fuel level (X) may initially be measured (by the fuel sensor), and/or may be set to a value indicating 100% capacity after refuelling. The fuel burn rates may be set to nominal values (or, in the worst case, if no nominal values are available the fuel burn rates may be set to zero).

State transition matrix F is:

$$F = [ \begin{matrix}1 & {t}_{L} & {t}_{TE} & {t}_{TL} & {t}_{SE} & {t}_{SL} \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] ( State Transition Matrix 1 )$$

Where for State Transition Matrix 1:
   t_{L}=the duration vehicle 100 is loading.
   t_{TE}=the duration vehicle 100 is travelling empty.
   t_{TL}=the duration vehicle 100 is travelling loaded.
   t_{SE}=the duration vehicle 100 is stationary and empty (with the engine running).
   t_{SL}=the duration vehicle 100 is stationary and loaded (with the engine running).
   The durations defined by the State Transition Matrix are measured using estimates of machine state (and transitions between states) as described above.

Measurement “vector” z is a scalar value representing the fuel level of the vehicle.

Transformation matrix H is:

H=[1 0 0 0 0 0] (Transformation Matrix 1)

### Example 2

In this embodiment, state vector x is defined as follows:

x=[X X′_{Stopped} X′_{EFHE} X′_{EFHL}]^{T} (State Vector 2)

State Vector 2 defines:
X=the fuel level of the vehicle 100.
X′_{Stopped}=the fuel burn rate of the vehicle 100 when the vehicle 100 is stationary (but the vehicle's engine is running).
X′_{EFHE}=the fuel burn rate per effective flat haul meter when empty.
X′_{EFHL}=the fuel burn rate per effective flat haul meter when loaded.

The effective flat haul meters for a given route (or route segment) travelled by a vehicle 100 is an estimate as to the equivalent distance that would be travelled by the vehicle 100 if the route (or route segment) was flat.

Effective flat haul meters for a given route segment may be calculated in a variety of ways. In one embodiment they are calculated based on the worksite terrain information, and in particular on the length, gradient (i.e. elevation gain or loss between the start and end of the route segment), and rolling resistance of the route segment. The total effective flat haul meters for a given route is then simply calculated by summing the effective flat haul meters of the segments that make up the route.

At 302 an initial estimate as to the state of the system (as defined by state vector x) is made.

State transition matrix F is:

$$F = [ \begin{matrix}1 & {t}_{Stopped} & {EFH}_{E} & {EFH}_{L} \\ 0 & 1 & 0 & 0 \\ 0 & 0 & 1 & 0 \\ 0 & 0 & 0 & 1\end{matrix} ] ( State Transition Matrix 2 )$$

Where for State Transition Matrix 2:
   t_{Stopped}=total time vehicle 100 is stationary (i.e. stationary but still running).
   EFH_{E}=effective flat haul distance vehicle 100 travels empty.
   EFH_{L}=effective flat haul distance vehicle 100 travels loaded.

Measurement “vector” z is a scalar value representing the fuel level of the vehicle.

Transformation matrix H is:

H=[1 0 0 0] (Transformation Matrix 2)

### Alternative Embodiments

Vehicle 100 may be fitted with different sensors providing additional information. By way of example, these may comprise: a speed sensor for sensing the speed of the vehicle 100; a RPM counter; a gear sensor for detecting the gear the vehicle 100 is operating in; an inclinometer for detecting an angle of inclination of the vehicle 100. Additional information on operation of the vehicle 100 may also be obtained manually and/or by other worksite sensors (e.g. sensors provided on other worksite machines, cameras, drones and the like). Process 300 may be modified to take into account such information in estimating the true fuel level of the vehicle 100.

It will be understood that embodiments extend to all alternative combinations of two or more of the individual features mentioned or evident from the text or drawings.

1. A computer-implemented method for estimating a true fuel level of a vehicle, the method comprising:
accessing an estimate as to a current state of the vehicle, the current state of the vehicle comprising a current fuel level state;
predicting the state of the vehicle at a future time based on the current state of the vehicle;
accessing a measured state of the vehicle based on sensor data;
estimating a true state of the vehicle based on the predicted state of the vehicle and the measured state of the vehicle, the true state of the vehicle comprising an estimate as to the true fuel level of the vehicle; and
outputting the estimated true fuel level of the vehicle.

2. A computer-implemented method according to claim 1, wherein the measured state of the vehicle comprises a measured fuel level sensed by a fuel level sensor of the vehicle.

3. A computer-implemented method according to claim 1, wherein the state of the vehicle at the future time is predicted using a difference equation.

4. A computer-implemented method according to claim 1, wherein the method further comprises estimating an error associated with the estimated true state of the vehicle.

5. A computer-implemented method according to claim 1, wherein the state of the vehicle is defined by a state vector, the state vector comprising elements defining: a fuel level of the vehicle, a fuel burn rate of the vehicle when the vehicle is stationary; a fuel burn rate of the vehicle per effective flat haul meter when empty; and a fuel burn rate of the vehicle per effective flat haul meter when loaded.

6. A computer-implemented method according to claim 1, wherein the state of the vehicle is defined by a state vector, the state vector comprising elements defining: a fuel level of the vehicle, a fuel burn rate of the vehicle during loading, a fuel burn rate of the vehicle when the vehicle is traveling empty, a fuel burn rate of the vehicle when the vehicle is traveling loaded, a fuel burn rate of the vehicle when the vehicle is stationary empty, and a fuel burn rate of the vehicle when the vehicle is stationary loaded.

7. A computer-implemented method according to claim 1, further comprising determining a refuelling assignment based on the estimated true fuel level of the vehicle.

8. A non-transitory computer-readable medium comprising instructions which, when implemented by a computer processing system, cause the computer processing system to:
access an estimate as to a current state of the vehicle, the current state of the vehicle comprising a current fuel level state;
predict the state of the vehicle at a future time based on the current state of the vehicle;
access a measured state of the vehicle based on sensor data;
estimate a true state of the vehicle based on the predicted state of the vehicle and the measured state of the vehicle, the true state of the vehicle comprising an estimate as to the true fuel level of the vehicle; and
output the estimated true fuel level of the vehicle.

9. A computer processing system comprising one or more processors configured to:
access an estimate as to a current state of the vehicle, the current state of the vehicle comprising a current fuel level state;
predict the state of the vehicle at a future time based on the current state of the vehicle;
access a measured state of the vehicle based on sensor data;
estimate a true state of the vehicle based on the predicted state of the vehicle and the measured state of the vehicle, the true state of the vehicle comprising an estimate as to the true fuel level of the vehicle; and
output the estimated true fuel level of the vehicle.
